(19) United States
(12) Patent Application Publication
(10) Pub. No.: US 2025/0016573 A1
(43) Pub. Date: Jan. 9, 2025

(54) CONTROL APPARATUS, CONTROL METHOD, COMPUTER READABLE MEDIUM, AND MOBILE COMMUNICATION SYSTEM

(71) Applicant: NEC Corporation, Minato-ku, Tokyo (JP)

(72) Inventor: Kenji FUKUI, Tokyo (JP)

(73) Assignee: NEC Corporation, Minato-ku, Tokyo (JP)

(21) Appl. No.: 18/577,310

(22) PCT Filed: Jul. 14, 2021
(86) PCT No.: PCT/JP2021/026435

§ 371 Date: Jan. 8, 2024

(51) Int. Cl. H04W 16/02; H04W 16/14; H04W 28/08

(52) U.S. Cl. CPC H04W 16/02; H04W 16/14; H04W 28/0846

(57) ABSTRACT

A control apparatus (10) includes: a receiving unit (11) configured to receive a request to lend a first resource of a mobile communication network (N1) to a certain operator; a control unit (12) configured to determine whether or not lending of the first resource to the certain operator should be permitted based on the request received by the receiving unit; and a transmitting unit (13) configured to transmit, to a relay apparatus (20) of the mobile communication network, a command for allocating the first resource to the certain operator when the lending is permitted by the control unit.

### TECHNICAL FIELD

The present disclosure relates to a control apparatus, a control method, a non-transitory computer readable medium storing a program, and a mobile communication system.

### BACKGROUND ART

Network slicing by which a network can be virtually divided and necessary resources can thereby be allocated has been known (e.g., Patent Literature 1). By such network slicing, for example, it is possible to provide (allocate) network resources according to the communication capacity and/or the communication speed required by a service or a solution that uses a network.

Further, in recent years, there is a mobile virtual network operator (MVNO (Mobile Virtual Network Operator)) that provides mobile communication services to users by using network resources provided by a mobile network operator (MNO (Mobile Network Operator)).

### CITATION LIST

### Patent Literature

Patent Literature 1: Published Japanese Translation of PCT International Publication for patent application, No. 2019-524003
Patent Literature 2: Japanese Unexamined Patent Application Publication No. 2002-158711

### SUMMARY OF INVENTION

### Technical Problem

However, in the technology disclosed in Patent Literature 1, for example, an MVNO cannot dynamically change network resources borrowed from (i.e., allocated by) an MNO.

In view of the above-described problem, an object of the present disclosure is to provide a technology for enabling an operator (e.g., a mobile network operator) to lend (i.e., allocate) resources of a mobile communication network to other operators (e.g., other mobile (virtual) network operators).

### Solution to Problem

In a first aspect according to the present disclosure, a control apparatus includes: a receiving unit configured to receive a request to lend a first resource of a mobile communication network to a certain operator; a control unit configured to determine whether or not lending of the first resource to the certain operator should be permitted based on the request received by the receiving unit; and a transmitting unit configured to transmit, to a relay apparatus of the mobile communication network, a command for allocating the first resource to the certain operator when the lending is permitted by the control unit.

Further, in a second aspect according to the present disclosure, a control method is provided. The control method includes: receiving a request to lend a first resource of a mobile communication network to a certain operator; determining whether or not lending of the first resource to the certain operator should be permitted based on the received request; and transmitting, to a relay apparatus of the mobile communication network, a command for allocating the first resource to the certain operator when the lending is permitted.

Further, in a third aspect according to the present disclosure, a non-transitory computer readable medium storing a program is provided. The program causes a computer to perform processes including: receiving a request to lend a first resource of a mobile communication network to a certain operator; determining whether or not lending of the first resource to the certain operator should be permitted based on the received request; and transmitting, to a relay apparatus of the mobile communication network, a command for allocating the first resource to the certain operator when the lending is permitted.

Further, in a fourth aspect according to the present disclosure, a mobile communication system is provided. The mobile communication system includes a control apparatus, a relay apparatus, and an operator apparatus, in which the operator apparatus transmits, to the control apparatus, a request to lend a first resource of a mobile communication network to a certain operator, the control apparatus includes: a receiving unit configured to receive the request from the operator apparatus; a control unit configured to determine whether or not lending of the first resource to the certain operator should be permitted based on the request received by the receiving unit; and a transmitting unit configured to transmit, to the relay apparatus of the mobile communication network, a command for allocating the first resource to the certain operator when the lending is permitted by the control unit, and the relay apparatus transfers, by using the first resource, data to be transmitted and received by a terminal of a subscriber of the certain operator.

### Advantageous Effects of Invention

According to an aspect, it is possible to enable an operator to lend resources of a mobile communication network to other operators.

### BRIEF DESCRIPTION OF DRAWINGS

FIG. 1 shows an example of a configuration of a control apparatus according to an example embodiment;

FIG. 2 shows an example of a configuration of a mobile communication system according to an example embodiment;

FIG. 3 shows an example of a hardware configuration of a control apparatus according to an example embodiment;

FIG. 4 is a sequence diagram showing an example of processes performed by a mobile communication system according to an example embodiment;

FIG. 5 shows an example of data recorded in a mobile virtual network operator DB according to an example embodiment; and

FIG. 6 shows an example of data recorded in a resource DB according to an example embodiment.

### EXAMPLE EMBODIMENT

The principle of the present disclosure will be described with reference to several illustrative example embodiments. It should be understood that these embodiments are described only for an illustrative purpose and will assist those skilled in the art in understanding and carrying out the present disclosure without suggesting any limitations in regard to the scope of the disclosure. Disclosures described in this specification can also be implemented in a variety of ways other than those described below.

In the following description and the claims, unless otherwise defined, all technical and scientific terms used in this specification have the same meanings as those generally understood by those skilled in the technical field to which the present disclosure belongs.

An example embodiment according to the present disclosure will be described hereinafter with reference to the drawings.

### First Example Embodiment

### <Configuration>

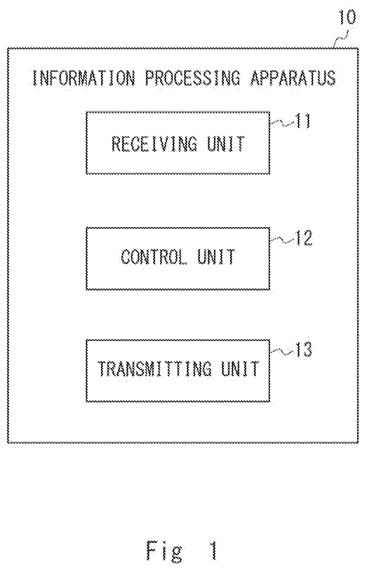

A configuration of a control apparatus 10 according to an example embodiment will be described with reference to FIG. 1. FIG. 1 shows an example of the configuration of the control apparatus 10 according to the example embodiment. The control apparatus 10 includes a receiving unit 11, a control unit 12, and a transmitting unit 13. These units may be implemented by cooperation of at least one program installed in the control apparatus 10 and hardware such as a processor 101 and a memory 102 of the control apparatus 10.

The receiving unit 11 receives data from an external apparatus such as an apparatus 60 of another operator (hereinafter also referred to as the other operator's apparatus 60). For example, the receiving unit 11 receives a request (lease request) to allocate resources of a mobile communication network to a certain operator (e.g., a mobile virtual network operator).

The control unit 12 determines, for example, whether or not the allocation of the resources to the certain operator is permitted based on the lease request received by the receiving unit 11. When the allocation is permitted by the control unit 12, the transmitting unit 13 transmits, to a relay apparatus of the mobile communication network, a command for allocating the resources to the certain operator.

### Second Example Embodiment

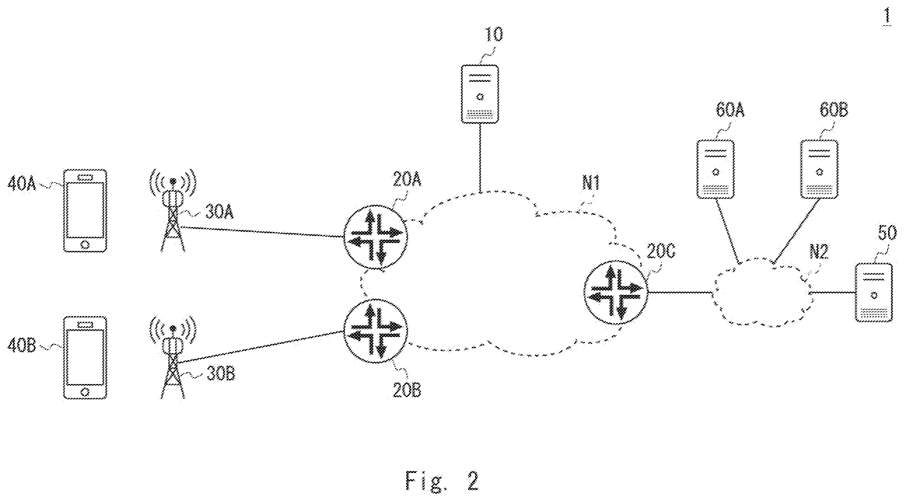

Next, a configuration of a mobile communication system 1 according to an example embodiment will be described with reference to FIG. 2.

### <System Configuration>

FIG. 2 shows an example of the configuration of the mobile communication system 1 according to the example embodiment. In FIG. 2, the mobile communication system 1 includes a control apparatus 10. Further, the mobile communication system 1 includes a relay apparatus 20A, a relay apparatus 20B, and a relay apparatus 20C (hereinafter, when they need not be distinguished from each other, they may be simply referred to as the “relay apparatus(es) 20”). Further, the mobile communication system 1 includes a base station (BS: Base Station) 30A and a base station 30B (hereinafter, when they need not be distinguished from each other, they may be simply referred to as the “base station(s) 30”). Further, the mobile communication system 1 include a terminal 40A and a terminal 40B (hereinafter, when they need not be distinguished from each other, they may be simply referred to as the “terminal(s) 40”).

Further, the mobile communication system 1 includes an external apparatus 50. Further, the mobile communication system 1 includes an other operator's apparatus 60A and an other operator's apparatus 60B (hereinafter, when they need not be distinguished from each other, they may be simply referred to as the “other operator's apparatus(es) 60”). Note that the numbers of control apparatuses 10, relay apparatuses 20, base stations 30, terminals 40, external apparatuses 50, and other operator's apparatuses 60 are not limited to those in the example shown in FIG. 2.

The control apparatus 10, the relay apparatuses 20, and the base stations 30 are connected so that they can communicate with each other through a mobile communication network N1. The mobile communication network N1 may be, for example, a network (internal network) operated by a mobile network operator (MNO). In this case, the mobile communication network N1 may be a core network of a fifth-generation mobile communication system (5G).

Further, the terminals 40, the external apparatuses 50, the control apparatus 10, and the other operator's apparatuses 60 are connected so that they can communicate with each other through the mobile communication network N1 and a network N2. The network N2 may be, for example, an external network such as the Internet.

Note that in the present disclosure, the term “base station” (BS: Base Station) refers to a device that can provide or host cells or coverages in which terminals 40 can perform communication. Examples of the base station 30 include, but are not limited to, a node B (Node B or NB), an Evolved Node B (eNode B or eNB), a next generation node B (gNB), a remote radio unit (RRU: Remote Radio Unit), a radio head (RH: Radio Head), a remote radio head (RRH: Remote Radio Head), and a low power node (e.g., a femto-node and a pico-node).

In the present disclosure, the term “terminal” refers to an arbitrary device having a wireless or wired communication function. Examples of the terminal 40 include, but are not limited to, user equipment (UE: User Equipment), a smartphone, a mobile phone, a cellular phone, a tablet-type computer, a personal computer, a desktop computer, a personal digital assistant (PDA: Personal Digital Assistant), a portable computer, an image capturing device such as a digital camera, a gaming device, a music storage and playback apparatus, and a wireless Internet apparatus.

The communication described in the present disclosure (mobile communication and wireless communication) may comply with arbitrary appropriate standards. Examples of standards include, but are not limited to, 5G (NR: New Radio), Beyond 5G (6G), 4G (LTE (Long Term Evolution) Advanced, WiMAX 2), Long Term Evolution (LTE), Wideband Code Division Multiple Access (W-CDMA), Code Division Multiple Access (CDMA), and Global System for Mobile (GSM). Further, the communication may be performed according to a communication protocol of any of generations that are currently known or will be developed in the future.

The control apparatus 10 provides (assigns, allocates, lends, or leases) resources of the mobile communication network N1 (hereinafter also referred to simply as “resources” as appropriate) to an operator such as a mobile virtual network operator by controlling the relay apparatus 20 in response to a request from the other operator's apparatus 60.

The relay apparatus 20 is a relay apparatus that forms at least a part of the mobile communication network N1. The relay apparatus 20 may be, for example, a layer-3 switch that relays packets based on information about a layer 3 (a network layer in an OSI reference model) or a router or the like. Alternatively, the relay apparatus 20 may be, for example, an optical switch that switches the path of optical signals that have been subjected to Wavelength Division Multiplexing (WDM). Note that in the example shown in FIG. 2, the relay apparatus 20C relays communication between the mobile communication network N1 and the network N2.

The external apparatus 50 is, for example, an information processing apparatus that transmits and receives data to and from terminals 40. The external apparatus 50 may be, for example, a web server. Alternatively, the external apparatus 50 may be a personal computer or the like that receives video images from terminals 40.

The other operator's apparatus 60 (i.e., each of the other operator's apparatuses 60) is an apparatus of an operator (e.g., a mobile virtual network operator) that borrows resources of the mobile communication network N1 from a mobile network operator that operates the mobile communication network N1 and provides mobile communication services to subscribers.

### <Hardware Configuration>

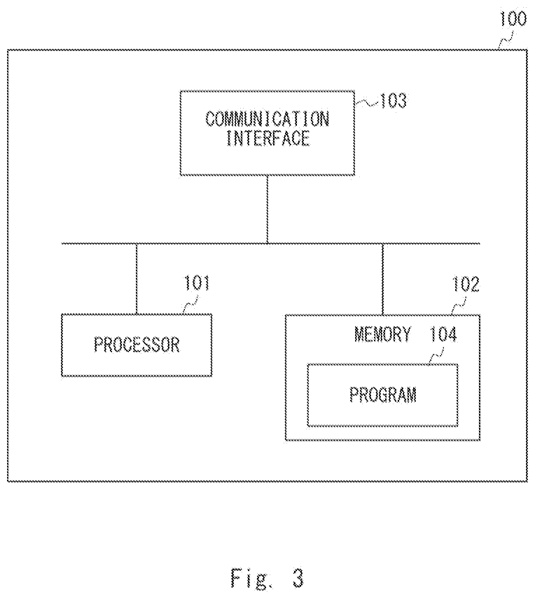

FIG. 3 shows an example of a hardware configuration of the control apparatus 10 according to the example embodiment. In the example shown in FIG. 3, the control apparatus 10 (computer 100) includes a processor 101, a memory 102, and a communication interface 103. These components may be connected to each other through a bus or the like. The memory 102 stores at least a part of a program(s) 104. The communication interface 103 includes an interface necessary for communicating with other network elements.

When the program 104 is executed by the cooperation of the processor 101, the memory 102, and the like, at least a part of the processing in the example embodiment according to the present disclosure is performed by the computer 100. The memory 102 may be of any type suitable for a local technology network. The memory 102 may be, but is not limited to, a non-transitory computer readable storage medium. Further, the memory 102 may be implemented by using any suitable data storage technology such as a semiconductor-based memory device, a magnetic memory device and system, an optical memory device and system, a fixed memory, and a removable memory. Although only one memory 102 is provided in the computer 100, a plurality of physically different memory modules may be provided in the computer 100. The processor 101 may be of any type. The processor 101 may include at least one of a general-purpose computer, a dedicated computer, a microprocessor, a digital signal processor (DSP: Digital Signal Processor), and, as a non-limiting example, a processor based on a multi-core processor architecture. The computer 100 may include a plurality of processors, such as an application-specific integrated circuit chip that is temporally dependent on a clock for synchronizing the main processor.

An example embodiment according to the present disclosure may be implemented by hardware, a dedicated circuit, software, a logic, or any combination thereof. In some aspects, an example embodiment may be implemented by hardware, while in other aspects, an example embodiment may be implemented by firmware or software that may be executed by a controller, a microprocessor, or other computing devices.

The present disclosure also provides at least one computer program product that is tangibly stored in a non-transitory computer readable storage medium. The computer program product contains computer executable instructions, such as those contained in program modules, and is executed by a target real processor or by a device on a virtual processor, so that a process(es) or a method according to the present disclosure is performed. The program module contains routines, programs, libraries, objects, classes, components, and data structures for performing specific tasks or implement specific abstract data types. The functions of the program module may be combined with those of the other program modules, or divided into a plurality of program modules as desired in various example embodiments. The machine executable instructions in the program module can be executed locally or in a distributed device(s). In the distributed device, the program module can be disposed on both local and remote storage media.

The program codes for performing the method according to the present disclosure may be written in any combination of at least one programming language. These program codes are provided to a processor or a controller of a general-purpose computer, a dedicated computer, or other programmable data processors. These program codes are provided to a processor or a controller of a general-purpose computer, a dedicated computer, or other programmable data processing apparatuses, and when such a program code is executed by the processor or the controller, a function/operation in a flowchart and/or a block diagram to be implemented is executed. The program code is entirely executed in a machine, partially executed in a machine as a standalone software package, partially executed in a machine, partially executed in a remote machine, or entirely executed in a remote machine or a server.

The program can be stored and provided to the computer by using any type of non-transitory computer readable media. Non-temporary computer readable media include various types of substantial recording media. Examples of non-transitory computer readable media include magnetic recording media, magneto-optical recording media, optical disk media, semiconductor memory, and the like. Examples of magnetic recording media include flexible disks, magnetic tapes, hard disk drives, and the like. Examples of magneto-optical recording media include magneto-optical disks and the like. Examples of optical disk media include Blu-ray disks, CD (Compact Discs)-ROM (Read Only Memory), CD-R (Recordable), CD-RW (ReWritable), and the like. Examples of semiconductor memories includes mask ROM, PROM (Programmable ROM), EPROM (Erasable PROM), flash ROM, RAM (random access memory), and the like. Further, the program may be supplied to the computer by various types of temporary computer readable media. Examples of transitory computer readable media include electric signals, optical signals, and electromagnetic waves. Temporary computer readable media can provide programs to computers through wired or wireless communication channels such as wires and optical fibers.

### <Processing>

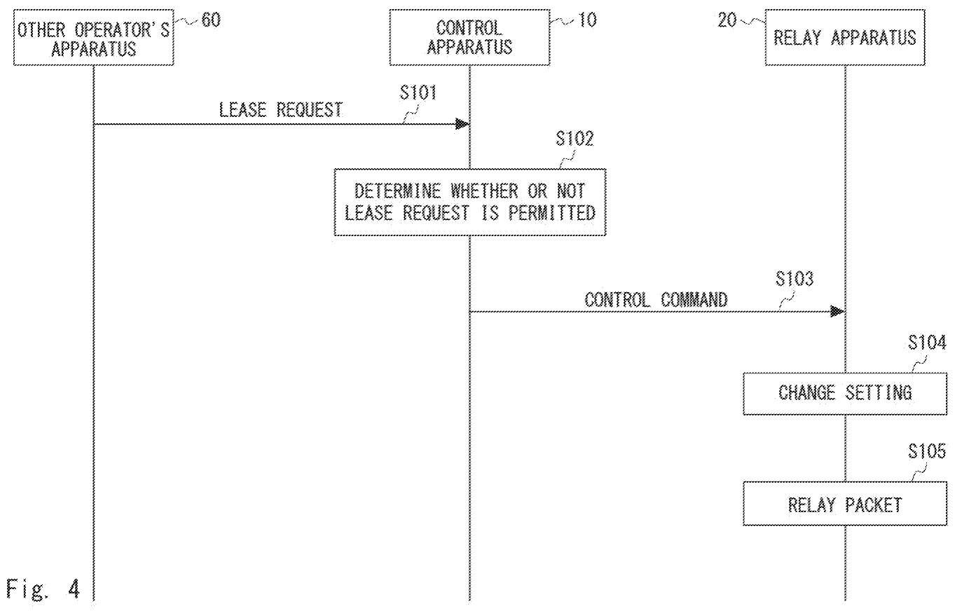

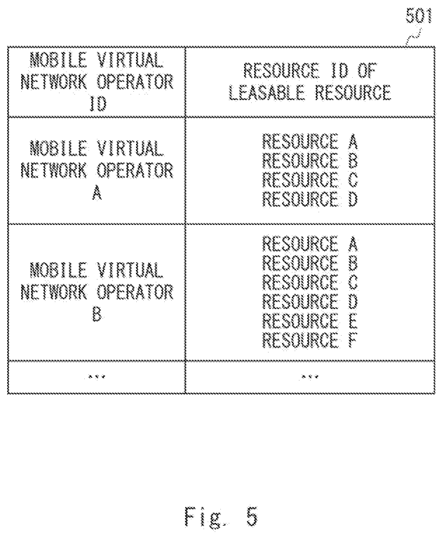

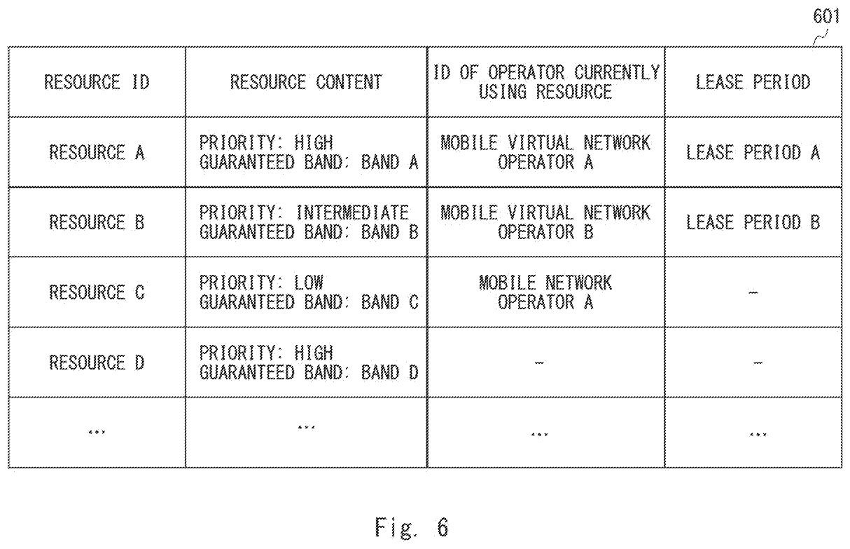

An example of processes performed by the mobile communication system 1 according to the example embodiment will be described with reference to FIGS. 4 to 6. FIG. 4 is a sequence diagram showing an example of processes performed by the mobile communication system 1 according to the example embodiment. FIG. 5 shows an example of data recorded in a mobile virtual network operator DB (Data Base) 501 according to the example embodiment. FIG. 6 shows an example of data recorded in a resource DB 601 according to the example embodiment.

In a step S101, an apparatus 60 of another operator (hereinafter also referred to as the other operator's apparatus 60) of a mobile virtual network operator transmits a lease request for resources of the mobile communication network N1 to the control apparatus 10 by using, for example, an API (Application Programming Interface) provided by a mobile network operator. Note that the other operator's apparatus 60 may determine resources to be leased based on, for example, the traffic volume of communication using the mobile communication network N1 performed by subscribers of the mobile virtual network operator. In this case, for example, the more the traffic volume increases, the larger quantity of resources the other operator's apparatus 60 requests to be leased. Further, the more the traffic volume decreases, the smaller quantity of resources the other operator's apparatus 60 requests to be leased. Alternatively, the other operator's apparatus 60 may request resources to be leased designated by an administrator (operator) or the like of the mobile virtual network operator in response to an operation performed by the administrator.

The lease request may include, for example, identification information of the mobile virtual network operator operating the other operator's apparatus 60 (e.g., a mobile virtual network operator ID), resource contents (e.g., information indicating QoS such as a priority and a frequency band), and information about the end of the lease period. Further, the lease request may include, for example, the below-shown parameters specified in various standards. In this way, for example, the mobile virtual network operator may designate network resources to be leased (changes in the configuration of the mobile communication network N1).
IETF RFC8466 “A YANG Data Model for Layer 2 Virtual Private Network (L2VPN) Service Delivery” (https://datatracker.ietf.org/doc/rfc8466/)
IETF rfc8049 “YANG Data Model for L3VPN Service Delivery” (https://datatracker.ietf.org/doc/rfc8049/)
GSMA “Generic Network Slice Template” (https://www.gsma.com/newsroom/resources/ng-116-generic-network-slice-template-v4-0/)

Next, the control unit 12 of the control apparatus 10 determines, for example, whether or not the received lease request should be permitted (accepted) by referring to a mobile virtual network operator DB 501 and a resource DB 601 (Step S102). In this way, for example, it is possible to determine whether or not the mobile virtual network operator has a right to receive the resources to be leased. Further, for example, it is possible to appropriately set (adjust) the allocation of resources among a plurality of mobile virtual network operators and mobile network operators. Note that mobile virtual network operator DB 501 and the resource DB 601 may be stored in a storage device disposed inside the control apparatus 10 or stored in an apparatus located outside the control apparatus 10.

In the example shown in FIG. 5, in the mobile virtual network operator DB 501, resource IDs of leasable resources are recorded in association with mobile virtual network operator IDs. The data stored in the mobile virtual network operator DB 501 may be registered by an administrator or the like of the mobile network operator when, for example, a contract is made between the mobile network operator and the mobile virtual network operator.

In the example shown in FIG. 6, in the resource DB 601, resource contents (QoS, quality of service), IDs of operators using resources, and the ends of the lease periods are recorded in association with resource IDs. The resource ID (i.e., each of resource IDs) is identification information of a resource of the mobile communication network N1 operated by the mobile network operator. A resource of the mobile communication network N1 may be, for example, a network slice obtained by dividing a physical network into a plurality of virtual independent logical networks by network slicing. The resource contents include, for example, information indicating QoS such as a priority and a frequency band. The ID of an operator using resources is identification information of a mobile virtual network operator or a mobile network operator using resources. When no data (NULL) is recorded in the field of the ID of an operator using a resource, it indicates that the resource is not currently leased to any mobile virtual network operator and that the mobile network operator itself is not using the resource. The end of the lease period indicates the date and time at which the period during which the resource is assigned to the operator ends.

Firstly, the control apparatus 10 may extract, from the resource DB 601 shown in FIG. 6, a resource ID(s) of at least one resource(s) that conforms to the resource contents designated in a lease request from a certain mobile virtual network operator and is not currently used by any operator. Then, the control apparatus 10 may determine whether or not the extracted resource ID is registered in the mobile virtual network operator DB 501 shown in FIG. 5 as a resource that can be leased to the mobile virtual network operator. Then, when it is not registered, the control apparatus 10 transmits an error response to the other operator's apparatus 60 and terminates the series of processes. On the other hand, when it is registered, the requested resource can be leased, so that the control apparatus 10 perform the below-shown processes.

An example of a process for determining a lease fee and a lease destination of a resource will be described hereinafter. The control apparatus 10 may perform the below-shown processes while combining them with one another as appropriate.

(Example in which Lease Fee is Determined)

The control apparatus 10 may determine a fee (lease fee) for a lease of a resource requested by a mobile virtual network operator based on the time zone of a lease period during which the resource is leased. In this way, it is possible to determine the lease fee more appropriately. In this case, in the control apparatus 10, information about the unit price per predetermined time (e.g., one minute) for each time zone may be defined in advance. Then, the control apparatus 10 may, for example, determine a period from the current time to the end of the lease period as a period during which the resource is leased (i.e., as the lease period). Then, the control apparatus 10 may calculate, as the lease fee, the sum of unit prices of all the predetermined times included in the lease period. In this way, the control apparatus 10 may, for example, increase the lease fee in a time zone during which it is expected that the traffic (communication volume) is relatively large, such as at night, and reduces the lease fee in a time zone during which it is expected that the traffic (communication volume) is relatively small, such as before dawn.

Further, the control apparatus 10 may determine the lease fee for the resource requested by the mobile virtual network operator based on the availability status of resources of the mobile communication network N1. In this way, it is possible to determine the lease fee more appropriately. In this case, firstly, the control apparatus 10 may refer to the resource DB 601 and calculate the total value of bands of, among resources having the priority requested by the mobile virtual network operator, resources that are not currently used by any operator. Then, the control apparatus 10 may determine a first coefficient related to the lease fee in such a manner that the smaller the calculated total value is, the larger the first coefficient becomes. Then, the control apparatus 10 may calculate, as the lease fee, for example, the sum of values each of which obtained by multiplying the first coefficient by the unit price or the like of a respective one of predetermined time periods included in the lease period. In this way, the control apparatus 10 may, for example, increase the lease fee when the availability of resources is relatively small, and reduces the lease fee when the availability of resources is relatively large.

Further, the control apparatus 10 may determine the lease fee for the resource requested by the mobile virtual network operator based on the ratio of resources already leased to the mobile virtual network operator to all the resources of the mobile communication network N1. In this way, it is possible to lease resources more appropriately. In this case, firstly, the control apparatus 10 may refer to the resource DB 601 and calculate the total value of bands of, among resources having the priority requested by the mobile virtual network operator, resources that are not currently leased to the mobile virtual network operator. Then, the control apparatus 10 may determine a second coefficient related to the lease fee in such a manner that the smaller the calculated total value is, the smaller the second coefficient becomes. Then, the control apparatus 10 may calculate, as the lease fee, for example, the sum of values each of which obtained by multiplying the second coefficient by the unit price or the like of a respective one of predetermined time periods included in the lease period. In this way, the control apparatus 10 may, for example, increase the lease fee when the leased resources are relatively large, and reduces the lease fee when the leased resources are relatively small. As a result, when the resources leased to the mobile virtual network operator is small, the lease fee is reduced, thus making it possible to invigorate the business of the mobile virtual network operator.

(Example in which Lease Destination is Determined)

When the control apparatus 10 is requested to lease the same resource from a plurality of mobile virtual network operators, it may determine the operator to which it will lease that resource based on the bidding prices of these operators. In this way, for example, it is possible to appropriately lease the resource. In this case, the control apparatus 10 may, for example, send a bidding request including information about a bidding ID, i.e., identification information of bidding, lease contents, and a lease period to the other operator's apparatus 60 of each of the operators. Then, the other operator's apparatus 60 of each of the operators may send back, to the control apparatus 10, a bidding response including the bidding ID, a mobile virtual network operator ID, and a bidding price. Then, the control apparatus 10 may determine an operator whose bidding price is the highest as the lease destination. In this case, the control apparatus 10 may determine a second highest bidding price (second price) as the lease fee. In this way, it is possible to determine the lease fee more appropriately.

Further, when the control apparatus 10 is requested to lease the same resource from a plurality of mobile virtual network operators, it may determine the operator to which it will lease that resource based on the records of leases to these operators. In this way, for example, it is possible to appropriately lease the resource. In this case, the control apparatus 10 may, for example, record, for each priority of resources leased to each operator, an integrated value obtained by multiplying a band that is leased in a predetermined period (e.g., one month) by a lease period as the lease record value. Then, for example, as the lease destination, the control apparatus 10 may determine, among operators whose conditions such as the bidding price are equivalent to each other, an operator whose lease record value for resources having the priority requested by these operators is the lowest. In this way, for example, it is possible to equally lease resources to the operators.

Further, when the control apparatus 10 is requested to lease the same resource from a plurality of mobile virtual network operators, it may determine the operator to which it will lease that resource based on the numbers of subscribers of these operators (the numbers of users who are under contract with the mobile virtual network operators). In this way, for example, it is possible to appropriately lease the resource. In this case, for example, the control apparatus 10 may determine, among the operators whose conditions such as the bidding price are equivalent to each other, an operator having the largest number of subscribers as the lease destination.

Further, when the control apparatus 10 is requested to lease the same resource from a plurality of mobile virtual network operators, it may determine the operator to which it will lease that resource based on, among the subscribers of these operators, the number of subscribers (the numbers of terminals 40) who (which) are in the service area or the like of the base station 30 of the mobile communication network N1. In this way, it is possible to appropriately lease resources even in the case where, for example, there is an operator of which the number of subscribers is relatively large due to a contract such as a free basic fee, but the number of subscribers actually using terminals 40 is relatively small.

Further, when the control apparatus 10 is requested to lease the same resource from a plurality of mobile virtual network operators, it may determine the operator to which it will lease that resource based on, among the subscribers of these operators, the number of subscribers (the numbers of terminals 40) who (which) are currently performing communication through the mobile communication network N1. In this way, it is possible to appropriately lease resources even in the case where, for example, there is an operator of which the number of subscribers is relatively large due to a contract such as a free basic fee, but the number of subscribers actually using terminals 40 is relatively small.

Next, the transmitting unit 13 of the control apparatus 10 transmits, to the relay apparatus 20, a control command for leasing the resource which is permitted to be leased to the mobile virtual network operator (Step S103). Note that the control apparatus 10 may, for example, make the relay apparatus 20 generate network slices in an IP layer such as segment routing (SRv6) using an IPv6 extended header, MPLS (Multi-Protocol Label Switching), VPN (Virtual Private Network), and VLAN (Virtual LAN). Further, the control apparatus 10 may, for example, make the relay apparatus 20 generate network slices by FlexE (Flex Ethernet) which was standardized by OIF (Optical Internetworking Forum). Note that in FlexE, for example, slices are generated by physically dividing the wavelength of an optical signal into fine bands (physical resources).

Next, the relay apparatus 20 makes a setting related to relaying based on the received control command (Step S104). Next, the relay apparatus 20 relays packets and the like based on this setting (Step S105). Note that when the relay apparatus 20 receives a packet transmitted from a terminal 40 or a packet to be transmitted to a terminal 40, it may extract identification information (e.g., IMSI (International Mobile Subscriber Identity) or the like) of the terminal 40 contained in the packet. Then, the relay apparatus 20 may, for example, determine the mobile virtual network operator or the like with which the user of the terminal 40 is under contract by referring to a subscriber management database (e.g., HLR (Home Location Register)/HSS (Home Subscriber Server)). Then, the relay apparatus 20 may transfer (relay) this packet by using a resource(s) (e.g., a slice(s))) currently allocated to the mobile virtual network operator or the like with which the user of the terminal 40 is under contract.

### Modified Example

The control apparatus 10 may be an apparatus housed in one housing, but the control apparatus 10 according to the present disclosure is not limited to this example. The control apparatus 10 may be implemented by, for example, a cloud computing system composed of at least one computer. Alternatively, the control apparatus 10 may be a server or an edge server that implements network virtualization (Network Functions Virtualization, NFV). Further, the relay apparatus 20 and/or the base station 30 may perform at least a part of processing of the control apparatus 10. Such control apparatuses 10 are also included in an example of the “control apparatus” according to the present disclosure.

Note that the present invention is not limited to the above-described example embodiments, and they can be modified as appropriate without departing from the scope and spirit of the invention.

The whole or part of the example embodiments disclosed above can be described as, but not limited to, the following supplementary notes.

### (Supplementary Note 1)

A control apparatus comprising:
a receiving unit configured to receive a request to lend a first resource of a mobile communication network to a certain operator;
a control unit configured to determine whether or not lending of the first resource to the certain operator should be permitted based on the request received by the receiving unit; and
a transmitting unit configured to transmit, to a relay apparatus of the mobile communication network, a command for allocating the first resource to the certain operator when the lending is permitted by the control unit.

### (Supplementary Note 2)

The control apparatus described in Supplementary note 1, wherein the certain operator is a mobile virtual network operator.

### (Supplementary Note 3)

The control apparatus described in Supplementary note 1 or 2, wherein the control unit lends the first resource to the certain operator when the first resource is included in lendable resources managed in association with the certain operator.

### (Supplementary Note 4)

The control apparatus described in any one of Supplementary notes 1 to 3, wherein the control unit determines a fee for lending the first resource to the certain operator based on a time zone of a period during which the first resource is lent to the certain operator.

### (Supplementary Note 5)

The control apparatus described in any one of Supplementary notes 1 to 4, wherein the control unit determines a fee for lending the first resource to the certain operator based on an availability status of resources of the mobile communication network.

### (Supplementary Note 6)

The control apparatus described in any one of Supplementary notes 1 to 5, wherein the control unit determines a fee for lending the first resource to the certain operator based on a ratio of resources already lent to a second operator other than a first operator managing the mobile communication network to all resources of the mobile communication network.

### (Supplementary Note 7)

The control apparatus described in any one of Supplementary notes 1 to 6, wherein when the lending of the first resource is requested from a plurality of operators, the control unit determines an operator to which it lends the first resource from the plurality of operators based on a bidding price from each of the plurality of operators.

### (Supplementary Note 8)

The control apparatus described in any one of Supplementary notes 1 to 7, wherein when the lending of the first resource is requested from a plurality of operators, the control unit determines an operator to which it lends the first resource from the plurality of operators based on a lending record of the first resource to each of the plurality of operators in a predetermined period.

### (Supplementary Note 9)

The control apparatus described in any one of Supplementary notes 1 to 8, wherein when the lending of the first resource is requested from a plurality of operators, the control unit determines an operator to which it lends the first resource from the plurality of operators based on the number of subscribers of each of the plurality of operators.

### (Supplementary Note 10)

The control apparatus described in any one of Supplementary notes 1 to 9, wherein when the lending of the first resource is requested from a plurality of operators, the control unit determines an operator to which it lends the first resource from the plurality of operators based on, among subscribers each of the plurality of operators, the number of subscribers who are in a service area of a base station of the mobile communication network

### (Supplementary Note 11)

The control apparatus described in any one of Supplementary notes 1 to 10, wherein when the lending of the first resource is requested from a plurality of operators, the control unit determines an operator to which it lends the first resource from the plurality of operators based on, among subscribers of each of the plurality of operators, the number of subscribers who are currently performing communication through the mobile communication network.

### (Supplementary Note 12)

A control method comprising:
receiving a request to lend a first resource of a mobile communication network to a certain operator;
determining whether or not lending of the first resource to the certain operator should be permitted based on the received request; and
transmitting, to a relay apparatus of the mobile communication network, a command for allocating the first resource to the certain operator when the lending is permitted.

### (Supplementary Note 13)

A non-transitory computer readable medium storing a program for causing a computer to perform processes including:
receiving a request to lend a first resource of a mobile communication network to a certain operator;
determining whether or not lending of the first resource to the certain operator should be permitted based on the received request; and
transmitting, to a relay apparatus of the mobile communication network, a command for allocating the first resource to the certain operator when the lending is permitted.

### (Supplementary Note 14)

A mobile communication system comprising a control apparatus, a relay apparatus, and an operator apparatus, wherein
the operator apparatus transmits, to the control apparatus, a request to lend a first resource of a mobile communication network to a certain operator,
the control apparatus comprises:
a receiving unit configured to receive the request from the operator apparatus;
a control unit configured to determine whether or not lending of the first resource to the certain operator should be permitted based on the request received by the receiving unit; and
a transmitting unit configured to transmit, to the relay apparatus of the mobile communication network, a command for allocating the first resource to the certain operator when the lending is permitted by the control unit, and
the relay apparatus transfers, by using the first resource, data to be transmitted and received by a terminal of a subscriber of the certain operator.

### (Supplementary Note 15)

The mobile communication system described in Supplementary note 14, wherein the certain operator is a mobile virtual network operator.

### REFERENCE SIGNS LIST

1 MOBILE COMMUNICATION SYSTEM
N1 MOBILE COMMUNICATION NETWORK
10 CONTROL APPARATUS
11 RECEIVING UNIT
12 CONTROL UNIT
13 TRANSMITTING UNIT
20 RELAY APPARATUS
30 BASE STATION
40 TERMINAL
50 EXTERNAL APPARATUS
60 OTHER OPERATOR'S APPARATUS

What is claimed is:

1. A control apparatus comprising:
at least one memory storing instructions, and
at least one processor configured to execute the instructions to:
receive a request to lend a first resource of a mobile communication network to a certain operator;
determine whether or not lending of the first resource to the certain operator should be permitted based on the request received by the receiving unit; and
transmit, to a relay apparatus of the mobile communication network, a command for allocating the first resource to the certain operator when the lending is permitted.

2. The control apparatus according to claim 1, wherein the certain operator is a mobile virtual network operator.

3. The control apparatus according to claim 1, wherein the at least one processor is configured to lend the first resource to the certain operator when the first resource is included in lendable resources managed in association with the certain operator.

4. The control apparatus according to claim 1, wherein the at least one processor is configured to determine a fee for lending the first resource to the certain operator based on a time zone of a period during which the first resource is lent to the certain operator.

5. The control apparatus according to claim 1, wherein the at least one processor is configured to determine a fee for lending the first resource to the certain operator based on an availability status of resources of the mobile communication network.

6. The control apparatus according to claim 1, wherein the at least one processor is configured to determine a fee for lending the first resource to the certain operator based on a ratio of resources already lent to a second operator other than a first operator managing the mobile communication network to all resources of the mobile communication network.

7. The control apparatus according to claim 1, wherein when the lending of the first resource is requested from a plurality of operators, the at least one processor is configured to determine an operator to which it lends the first resource from the plurality of operators based on a bidding price from each of the plurality of operators.

8. The control apparatus according to claim 1, wherein when the lending of the first resource is requested from a plurality of operators, the at least one processor is configured to determine an operator to which it lends the first resource from the plurality of operators based on a lending record of the first resource to each of the plurality of operators in a predetermined period.

9. The control apparatus according to claim 1, wherein when the lending of the first resource is requested from a plurality of operators, the at least one processor is configured to determine an operator to which it lends the first resource from the plurality of operators based on the number of subscribers of each of the plurality of operators.

10. The control apparatus according to claim 1, wherein when the lending of the first resource is requested from a plurality of operators, the at least one processor is configured to determine an operator to which it lends the first resource from the plurality of operators based on, among subscribers each of the plurality of operators, the number of subscribers who are in a service area of a base station of the mobile communication network.

11. The control apparatus according to claim 1, wherein when the lending of the first resource is requested from a plurality of operators, the at least one processor is configured to determine an operator to which it lends the first resource from the plurality of operators based on, among subscribers of each of the plurality of operators, the number of subscribers who are currently performing communication through the mobile communication network.

12. A control method comprising:
receiving a request to lend a first resource of a mobile communication network to a certain operator;
determining whether or not lending of the first resource to the certain operator should be permitted based on the received request; and
transmitting, to a relay apparatus of the mobile communication network, a command for allocating the first resource to the certain operator when the lending is permitted.

13. A non-transitory computer readable medium storing a program for causing a computer to perform processes including:
receiving a request to lend a first resource of a mobile communication network to a certain operator;
determining whether or not lending of the first resource to the certain operator should be permitted based on the received request; and
transmitting, to a relay apparatus of the mobile communication network, a command for allocating the first resource to the certain operator when the lending is permitted.

14. (canceled)

15. (canceled)
